(19) United States
(12) Patent Application Publication
(10) Pub. No.: US 2024/0000094 A1
(43) Pub. Date: Jan. 4, 2024

(54) EMULSIFIED COMPOSITION, AND FOOD OR DRINK PRODUCT

(71) Applicants: KEWPIE CORPORATION, Tokyo (JP); Kewpie Jyozo Co., Ltd., Tokyo (JP)

(72) Inventors: Hideaki KOBAYASHI, Tokyo (JP); Mayumi HIDAN, Tokyo (JP); Akifumi MIKAMI, Tokyo (JP)

(73) Assignees: KEWPIE CORPORATION, Tokyo (JP); Kewpie Jyozo Co., Ltd., Tokyo (JP)

(21) Appl. No.: 18/038,303

(22) PCT Filed: Nov. 19, 2021
(86) PCT No.: PCT/JP2021/042606

§ 371 Date: May 23, 2023

(30) Foreign Application Priority Data
Nov. 30, 2020 (JP) 2020-198885

(51) Int. Cl. A23D 7/005; A23D 7/01; A23L 33/115; A23L 23/00

(52) U.S. Cl. CPC A23D 7/0053; A23D 7/011; A23L 33/115; A23L 23/00

(57) ABSTRACT

An emulsified composition, which allows fat and oil to be easily and uniformly dispersed in a food or drink product when added to the food or drink product, is provided.

The present invention provides an emulsified composition for adding fat and oil to a food or drink product, wherein
the emulsified composition contains fat and oil, an ionic surfactant, and a polyhydric alcohol,
a content of the fat and oil is 5% by mass or more and 65% by mass or less with respect to a total amount of the emulsified composition,
a content of the ionic surfactant is 0.3% by mass or more and 6.0% by mass or less with respect to the total amount of the emulsified composition,
the ionic surfactant contains at least lecithin and/or lysolecithin,
the emulsified composition has a specific gravity of 1.0 or more at 20° C. and
a viscosity of 60,000 mPa·s or less at 20° C., and
a difference of L2 value-L1 value calculated by the following definition at 20° C. is positive:
L1 value: lightness value of the emulsified composition;
L2 value: lightness value of the emulsified composition obtained by adding 100 times by mass of fresh water to the emulsified composition.

### TECHNICAL FIELD

The present invention relates to an emulsified composition. In particular, the present invention relates to an emulsified composition containing fat and oil, an ionic surfactant, and a polyhydric alcohol. The present invention also relates to a food or drink product to which the emulsified composition is added.

### Background Art

Lipids are so important nutrients for the human body that they can be cited as one of the three major nutrients. Meanwhile, as a cause of obesity, active intake of lipids has been avoided for some time. However, according to recent research results, carbohydrates are attracting more attention than lipids as causative nutrients for obesity. Furthermore, recognition of functional fats and oils such as omega-3 fats and oils (DHA, EPA, and α-linolenic acid) has been spreading, and the demand for proactively ingesting fats and oils has increased.

In Japan, where the population is aging, undernutrition has become an important social issue. To prevent and improve undernutrition, it is necessary to eliminate energy and protein deficiencies. Three nutrients produce energy: carbohydrates, lipids, and proteins; 1 g of carbohydrates equals 4 kcal, 1 g of lipids equals 9 kcal, and 1 g of protein equals 4 kcal. In other words, the most efficient way to take in energy is to incorporate fats and oils into diet. Furthermore, it is difficult for people who have difficulty in chewing and/or swallowing, and who have difficulty in ingesting solid foods, and who are on the dysphagia diet as a regular diet for swallowing to consume fats and oils from meat and fish. Therefore, incorporating fats and oils into the diet is one of the most important issues.

However, since fats and oils are usually not easily mixed with water, they separate when added to, for example, drinks. It has been necessary to devise ways to incorporate them into daily eating habits. Care should be taken as consuming a large amount of separated fats and oils can easily cause diarrhea. Given such circumstances, a technology has been disclosed in which fats and oils are obtained in an emulsified state by emulsifying and then pulverizing fats and oils to dissolve them in a liquid easily. However, this method requires equipment for pulverization, and the production process is complicated. Therefore, as an emulsified composition having a high oil content that forms fine oil droplets after being diluted with water, an O/D type emulsified composition containing a polyhydric alcohol, an oil-soluble substance (other than an emulsifier) at 60% by mass or more and less than 90% by mass, and an emulsifier in which 51% by mass or more of a constituent fatty acid has 10 or more carbon atoms, an HLB value is greater than 10, and an iodine value is less than 10 (A), in which the content of an emulsifier (B) having an HLB value of greater than 10 and an iodine value of or more is less than 5% by mass, and the content of an oil-soluble emulsifier (C) having an HLB value of 10 or less is less than 1/20 of the total content of the emulsifier (A) and the emulsifier (B), has been proposed (see Patent Literature 1).

### CITATION LIST

### Patent Literature

Patent Literature 1: Japanese Laid-Open Patent Publication No. 2017-143753

### Technical Problem

### SUMMARY OF THE INVENTION

However, the emulsified composition as described in Patent Literature 1 has a high viscosity and a low specific gravity due to its high content of fat and oil, and is inferior in workability for adding fat and oil to a food or drink product. Therefore, there is still a demand for a technique that can improve the dispersibility of fats and oils with minimal stirring when fats and oils are added to food or drink products. In particular, when fats and oils are added as part of the step of industrially producing a food product, it is common to use equipment that has a stirring function to stir the whole to no small extent. In this respect, a certain degree of dispersibility is sufficient. Meanwhile, when fats and oils are added to foods and drinks immediately before ingested by consumers at home, facilities and offices, and the like, the ability to disperse with minimal stirring greatly improves the ease of use.

Therefore, an object of the present invention is to provide an emulsified composition which allows fat and oil to be easily and uniformly dispersed in a food or drink product when added to the food or drink product.

### Solution to Problem

As a result of intensive studies on the above-described problems, the present inventors found that the problems can be solved by adjusting the viscosity of an emulsified composition and adjusting the difference in lightness between the emulsified composition and a dilution thereof. The present inventors have completed the present invention based on these findings.

Specifically, according to one aspect of the present invention,
an emulsified composition for adding fat and oil to a food or drink product, wherein
the emulsified composition contains fat and oil, an ionic surfactant, and a polyhydric alcohol,
a content of the fat and oil is 5% by mass or more and 65% by mass or less with respect to a total amount of the emulsified composition,
a content of the ionic surfactant is 0.3% by mass or more and 6.0% by mass or less with respect to the total amount of the emulsified composition,
the ionic surfactant contains at least lecithin and/or lysolecithin,
the emulsified composition has a specific gravity of 1.0 or more at 20° C. and
a viscosity of 60,000 mPa·s or less at 20° C., and
a difference of L2 value-L1 value calculated by the following definition at 20° C. is positive:
L1 value: lightness value of the emulsified composition;
L2 value: lightness value of the emulsified composition obtained by adding 100 times by mass of fresh water to the emulsified composition, is provided.

In an aspect of the present invention, it is preferable that the content of the ionic surfactant is 0.15 parts by mass or less with respect to 1 part by mass of the content of the fat and oil.

In an aspect of the present invention, it is preferable that the polyhydric alcohol contains a sugar alcohol.

In an aspect of the present invention, the average molecular weight of the sugar alcohol is preferably 100 or more and 2000 or less.

In an aspect of the present invention, the content of the polyhydric alcohol is preferably 20% by mass or more in terms of solid content with respect to the total amount of the emulsified composition.

In an aspect of the present invention, the moisture content is preferably 5% by mass or more with respect to the total amount of the emulsified composition.

In an aspect of the present invention, the difference of L2 value-L1 value is preferably 10.0 or more.

In an aspect of the present invention, it is preferable that the food or drink product is selected from the group consisting of a drink, a liquid food, a liquid nutritional food, and a food or drink product for those with difficulty in chewing and/or swallowing.

According to another aspect of the present invention,
an emulsified composition for adding fat and oil to a liquid nutritional food or a food or drink product for those with difficulty in chewing and/or swallowing, having
a viscosity of 60,000 mPa·s or less at 20° C.,
a difference of L2 value-L1 value calculated by the following definition at 20° C. is positive:
L1 value: lightness value of the emulsified composition;
L2 value: lightness value of the emulsified composition obtained by adding 100 times by mass of fresh water to the emulsified composition, is provided.

According to another aspect of the present invention, a food or drink product, to which the emulsified composition described above is added, is provided.

### Advantageous Effects of Invention

According to the present invention, an emulsified composition which allows fat and oil to be easily and uniformly dispersed in a food or drink product when added to the food or drink product can be provided.

### DESCRIPTION OF EMBODIMENTS

### <Emulsified Composition>

The emulsified composition of the present invention usually contains fat and oil, an ionic surfactant, and a polyhydric alcohol, and is intended for the ease of addition of fat and oil to a food or drink product. By adding the emulsified composition of the present invention to a food or drink product, fat and oil can be easily and uniformly dispersed in the food or drink product.

### (Food or Drink Product)

According to the present invention, the food or drink product is not particularly limited and may be a known food or drink product. Examples of the food or drink product can include a drink, a liquid food (e.g., soup, curry, or stew), a liquid nutritional food, a food or drink product for those with difficulty in chewing and/or swallowing (e.g., mousse or puree), yogurt, and a seasoning. It is preferable that the food or drink product has fluidity. In particular, for the purpose of nutritional support, it is favorable to add the emulsified composition to a liquid nutritional food or a food or drink product for those with difficulty in chewing and/or swallowing in that it is particularly useful to mix fat and oil easily according to the required amount immediately before ingestion. Even in a case in which the food or drink product does not have fluidity, it can be added at the time when it has fluidity in the production step, or it can be added in advance to other raw materials having fluidity.

### (L Value)

When measuring the L value that represents the lightness of color using a colorimetric color difference meter at 20° C., the emulsified composition has the property of having a positive value of the difference between the lightness, L1 value, of the emulsified composition and the lightness, L2 value, of an emulsion obtained by adding 100 times by mass of fresh water to the emulsified composition (L2 value-L1 value).

The L value is a numerical value representing the lightness of a color, and the larger the value, the brighter the color. In the case of an emulsified composition, as the emulsified particles become finer, the amount of scattered light increases and the particles become whitish. Accordingly, the L value increases. The change in the L value in the present invention is caused by adding the emulsified composition to water, which causes a phase transition, resulting in an emulsified composition in which fat and oil are finely divided into fine particles, resulting in cloudiness and a decrease in transparency. The L value can be measured using a colorimetric color difference meter (trade name: “Color Meter ZE-2000” manufactured by NIPPON DENSHOKU INDUSTRIES CO., LTD.) in the present invention.

“Self-emulsifiability” refers to the property of easily being an emulsified state (0/W emulsification) in which oil and fat are microparticulate by adding water to the oil and fat. The emulsified composition of the present invention maintains the state before forming an O/W emulsified composition due to self-emulsification with the addition of water. Self-emulsifiability is a feature found in a system in which an infinite aggregate of molecules that aggregate infinitely is formed, such as a liquid crystal, a bicontinuous microemulsion (BCME), in which surfactant molecules aggregate infinitely, or the like. There is a proportional relationship between the stability of the system and the high self-emulsifiability. The details of the structure of the emulsified composition of the present invention are not clear. However, as the emulsified composition of the present invention exhibits self-emulsifiability by adding water, it is presumed to be a system in which an infinite aggregate is formed or a system having a state similar thereto. The emulsified composition of the present invention can improve workability when used at home, facilities, offices, and the like because emulsification can be easily achieved immediately after the emulsified composition is added. In addition, since the emulsified composition of the present invention does not need to be pre-emulsified, it is also possible to prevent oxidative deterioration of oil and fat.

When the emulsified composition of the present invention has a high level of self-emulsifiability, the size of the fat and oil particles in the 0/W emulsified composition obtained when a large amount of water is added becomes small, resulting in a large L2 value. Since the level of self-emulsifiability is proportional to the stability of the emulsified composition as described above, the L2 value represents the stability of the emulsified composition. Therefore, the greater the difference between the L1 value of the emulsified composition (in a state before adding water) and the L2 value of the emulsified composition obtained by adding 100 times by mass of water to the emulsified composition (L2 value-L1 value), the more stable the structure of the emulsified composition is maintained. Thus, emulsification can be readily achieved.

According to the present invention, the difference of L2 value-L1 value for the emulsified composition is positive and preferably 10 or more, more preferably 15 or more. As long as the difference of L2 value-L1 value for the emulsified composition is positive, the emulsified composition can be easily emulsified such that workability can be improved.

### (Specific Gravity of Emulsified Composition)

The specific gravity of the emulsified composition is usually 1.0 or more, preferably 1.03 or more, more preferably 1.05 or more, still more preferably 1.10 or more, and also preferably 1.5 or less, more preferably 1.4 or less, still more preferably 1.3 or less. When the specific gravity of the emulsified composition is less than 1.0, the emulsified composition itself tends to float on the liquid surface when added to a food or drink product, making it difficult to efficiently disperse fat and oil. Meanwhile, when the specific gravity of the emulsified composition is 1.0 or more, the emulsified composition tends to settle in a food or drink product when added to the food or drink product, and fat and oil can be easily dispersed.

The specific gravity of the emulsified composition can be measured by the following method of measuring specific gravity.

Specific gravity measurement method: 5.00 g of an emulsified composition is accurately weighed into a graduated centrifuge tube and centrifuged (2,000 rpm, 5 minutes), thereby removing air bubbles. The volume of this emulsified composition is measured from the scale at a sample temperature of 20.0° C. As a control, ion-exchanged water was similarly measured and found to have a volume of 5.00 mL. Based on these measurement results, the specific gravity of the emulsified composition is calculated by the following formula.

Specific gravity=5.00 mL/(volume in mL of each emulsified composition)

### (Viscosity of Emulsified Composition)

The viscosity of the emulsified composition at 20° C. is 60,000 mPa s or less, preferably 40,000 mPa s or less, more preferably 30,000 mPa s or less, still more preferably 15,000 mPa s or less, yet still more preferably 10,000 mPa s or less, most preferably 6,000 mPa s or less, and also preferably 100 mPa·s or more, more preferably 500 mPa·s or more, still more preferably 1,000 mPa·s or more. As long as the viscosity of the emulsified composition is within the above-described range, workability can be improved when adding the emulsified composition to a food or drink product.

The viscosity of the emulsified composition is a value that is calculated using a BL-type viscometer at a product temperature of 20° C. and a rotation speed of 6 rpm, based on the reading after 3 minutes from the start of measurement using No. 2 rotor when the viscosity is less than 3000 mPa·s, No. 3 rotor when the viscosity is 3000 mPa·s or more and less than 5000 mPa·s, and No. 4 rotor when the viscosity is 5000 mPa·s or more.

### (Fat and Oil)

The fat and oil compounded in the emulsified composition are not particularly limited, and conventionally known edible fats and oils can be used. Specific examples of edible fats and oils that can be used include vegetable oils such as rapeseed oil, soybean oil, corn oil, palm oil, cottonseed oil, sunflower oil, safflower oil, sesame oil, olive oil, linseed oil, rice oil, camellia oil, perilla sesame oil, grapeseed oil, peanut oil, almond oil, and avocado oil, fish oil, algal oil containing DHA, beef tallow, lard, chicken fat, and fats and oils obtained by chemical or enzymatic treatment, such as MCT (medium-chain fatty acid triglyceride), diglyceride, hydrogenated oil, and transesterified oil. It is more preferable from a standpoint of health that these natural fats and oils contain phytochemicals (such as vitamin K, vitamin D, tocopherol, tocotrienol, γ-oryzanol, and polyphenol). Among these, it is preferable to use vegetable oils and fats, and it is more preferable to use rapeseed oil, soybean oil, corn oil, or a mixed oil thereof.

The content of fat and oil is usually 5% by mass or more and 65% by mass or less, preferably 60% by mass or less, more preferably 55% by mass or less, still more preferably 50% by mass or less, and also preferably 8% by mass or more, more preferably 10% by mass or more, still more preferably 15% by mass or more, and yet still more preferably 20% by mass or more with respect to the total amount of the emulsified composition. The specific gravity becomes low when the fat and oil content exceeds 65% by mass. Thus, when the emulsified composition is added to a food or drink product, the fat or oil may float, resulting in poor dispersibility. Therefore, by adding an emulsified composition in which the specific gravity is adjusted to a desired range by adjusting the content of fat and oil to 65% by mass or less, fat and oil can be easily and uniformly dispersed in a food and drink product.

### (Ionic Surfactant)

The ionic surfactant compounded in the emulsified composition ionizes and generates ions when dissolved in water. In particular, using a zwitterionic ionic surfactant, the emulsified state of the emulsified composition can be stably maintained even when the surfactant content is small, and viscosity and flavor can be easily adjusted. Meanwhile, to stably maintain an emulsified state using a nonionic surfactant, it is necessary to add a large amount of the surfactant, which is undesirable in terms of physical properties, flavor, and cost. In the present invention, among the ionic surfactants, lecithin (phospholipid) is preferably used because it facilitates the emulsified state of the emulsified composition. Phospholipids are lipids having phosphate and phosphonate esters and are amphiphiles having both hydrophilic and hydrophobic groups. Examples of phospholipids include: glycerophospholipids having a glycerol skeleton such as phosphatidylcholine, phosphatidylethanolamine, phosphatidylserine, and phosphatidylinositol; and sphingophospholipids having a sphingosine skeleton such as sphingomyelin. Among phospholipids, phosphatidylcholine, phosphatidylethanolamine, and phosphatidylinositol are preferably used. A mixture containing these phospholipids is preferably used.

Examples of lecithins include plant lecithins such as soybean lecithin, rapeseed lecithin, and sunflower lecithin, and egg yolk lecithin. It is preferable to use a plant lecithin because it is derived from a plant. By using lecithin, it becomes easier to maintain an emulsified state even when the moisture content is high. When a mixture containing a phospholipid is used, the included phospholipid portion corresponds to the ionic surfactant of the present invention. For example, when egg yolk lecithin (such as PL-30 or LPL-20S manufactured by Kewpie Corporation) is used, the phospholipid contained in the mixture corresponds to the ionic surfactant of the present invention, and the egg yolk oil portion corresponds to the fat and oil of the present invention.

### (Lysophospholipid)

In the present invention, lysolecithin (lysophospholipid) that is a lysoform of the above-described lecithin (phospholipid) may be used. Using lysophospholipid, the emulsified state of the emulsified composition can be further stably maintained such that viscosity and flavor can be easily adjusted. It is preferable to use, for example, lysophosphatidylcholine, lysophosphatidylethanolamine, or lysophosphatidylinositol as lysolecithin.

The content of the ionic surfactant is usually 0.3% by mass or more and 6.0% by mass or less, preferably 0.5% by mass or more and 5.5% by mass or less, more preferably 0.6% by mass or more and 5.0% by mass or less with respect to the total amount of the emulsified composition. In addition, the content of the ionic surfactant is preferably 0.15 parts by mass or less, more preferably 0.10 parts by mass or less, and still more preferably 0.09 parts by mass with respect to 1 part by mass of the content of fat and oil. As long as the content of the ionic surfactant is within the above-described range, fat and oil can be easily and uniformly dispersed in a food or drink product by maintaining the viscosity of the emulsified composition at a low level and adding the emulsified composition to the food or drink product.

### (Polyhydric Alcohol)

The polyhydric alcohol compounded in the emulsified composition collectively refers to alcohols having two or more hydroxy groups in the molecule. Examples thereof include: glycerin, ethylene glycol, propylene glycol, or a polymer thereof; alkanediols such as 1,3-butanediol, 1,4-butanediol, and 1,2-propanediol; and sugar alcohols such as maltitol, lactitol, sorbitol, xylitol, erythritol, reduced palatinose, and reduced starch syrup. Among these, glycerin and sugar alcohols are preferable, and sugar alcohols are more preferable. Further, the average molecular weight of a sugar alcohol is preferably 100 or more and 2000 or less, more preferably 150 or more and 1000 or less. As long as the average molecular weight of the sugar alcohol is within the above-described range, when the emulsified composition is added to a food and drink product, fat and oil can be easily and uniformly dispersed in the food or drink product without affecting the flavor of the food or drink product.

The content of the polyhydric alcohol is preferably 20% by mass or more, more preferably 25% by mass or more, still more preferably 30% by mass or more, yet still more preferably 35% by mass or more, and also preferably 60% by mass or less, more preferably 55% by mass or less, still more preferably 50% by mass or less in terms of solid content with respect to the total amount of the emulsified composition. As long as the content of the polyhydric alcohol is within the above-described numerical range, fat and oil can be easily and uniformly dispersed in a food or drink product by adding the emulsified composition to the food or drink product.

### (Moisture)

The emulsified composition may contain moisture for emulsification and viscosity adjustment. To adjust moisture, the emulsified composition may be compounded with fresh water or with a raw material containing moisture to be compounded, for example, a liquid sugar containing moisture as polyhydric alcohol.

The moisture content is preferably 5% by mass or more, more preferably 10% by mass or more, still more preferably 13% by mass or more, yet still more preferably 15% by mass or more, and also preferably 30% by mass or less, more preferably 25% by mass or less, still more preferably 22% by mass or less with respect to the total amount of the emulsified composition. By adjusting the moisture content within the above-described range, the dispersibility of fat and oil in a food and drink product can be improved when adding the emulsified composition to the food or drink product.

### (Other Raw Materials)

The emulsified composition can be compounded with various raw materials usually used in emulsified compositions, which can be selected as appropriate, in addition to the above-described raw materials to the extent that the effects of the present invention are not impaired. Examples of other raw materials include acetic acid, citric acid, amino acids, salts, sweeteners, thickeners, coloring agents, flavoring agents, and preservatives.

### (Method of Preparing Emulsified Composition)

The method of preparing an emulsified composition is not particularly limited, and conventionally known methods can be used. For example, an emulsified composition can be prepared by loading an ionic surfactant, a polyhydric alcohol, and optionally, fresh water and other raw materials such as a salt and a sweetener into a stirring tank, stirring and mixing the mixture using a mixer to homogenize the mixture, and then gradually adding an edible oil while stirring.

### (Production Equipment)

To prepare the emulsified composition of the present invention, equipment used in ordinary food production can be used. Examples of such equipment include a general stirrer, a stick mixer, a stand mixer, a homomixer, and a homodisper. Examples of the shape of the stirring blades of the stirrer include propeller blades, turbine blades, paddle blades, and anchor blades.

### EXAMPLES

The present invention will be described in more detail below with reference to Examples and Comparative Examples, but the present invention should not be construed as being limited to the contents of the following Examples.

### Examples 1 to 8, Comparative Examples 1 to 4

### <Preparation of Emulsified Composition>

Emulsified compositions were prepared according to the mixing proportions shown in Table 1. Specifically, a polyhydric alcohol (sugar alcohol (with an average molecular weight of 150 or more and 1000 or less) or glycerin), lysophospholipid (lysoform of egg yolk lecithin) as an ionic surfactant, and optionally, water were added to a glass beaker and stirred and mixed with an anchored propeller such that the mixture was homogenized. Thereafter, while stirring was continued, edible fat and oil (such as rapeseed oil) were gradually added, thereby preparing an emulsified composition.

### <Evaluation of Emulsified Composition>

### Measurement of L Value

Using the emulsified compositions prepared above, the L value of each sample before and after dilution with water was measured three times at by the following method. The average was obtained to calculate the difference of L2 value-L1 value.

### Measuring Apparatus

Colorimetric color difference meter (Color Meter ZE-2000 manufactured by NIPPON DENSHOKU INDUSTRIES CO., LTD.).

### Measurement Conditions

L1 value: lightness value of emulsified composition

The emulsified composition before dilution with water was placed in an amount of 1.5 g in a circular cell and subjected to measurement.

L2 value: lightness value of emulsified composition obtained by adding 100 times by mass of fresh water to the emulsified composition

The emulsified composition before dilution was collected in an amount of 0.2 g in a beaker, and 20.0 g of fresh water was added, followed by stirring. The obtained sample diluted with water was placed in an amount of 1.5 g in a circular cell and subjected to measurement.

### (Measurement of Specific Gravity)

The specific gravity of the emulsified composition prepared above was measured by the following specific gravity measurement method, and the measurement results are shown in Table 1.

Specific gravity measurement method: 5.00 g of the emulsified composition was accurately weighed into a graduated centrifuge tube and centrifuged (2,000 rpm, 5 minutes), thereby removing air bubbles. The volume of this emulsified composition was measured from the scale at a sample temperature of 20.0° C. As a control, ion-exchanged water was similarly measured and found to have a volume of 5.00 mL. Based on these measurement results, the specific gravity of the emulsified composition was calculated by the following formula.

Specific gravity=5.00 mL/(volume in mL of each emulsified composition)

For Comparative Examples 1 and 2 in which measurement was not possible because the emulsified composition separated immediately after production, the results are indicated as unmeasured (“-”) in Table 1.

### (Measurement of Viscosity)

The viscosity (mPa·s) of the emulsified composition prepared above was calculated using a BL-type viscometer at a product temperature of 20° C. and a rotation speed of 6 rpm, based on the reading after 3 minutes from the start of measurement using No. 2 rotor when the viscosity was less than 3000 mPa·s, No. 3 rotor when the viscosity was 3000 mPa·s or more and less than 5000 mPa·s, and No. 4 rotor when the viscosity was 5000 mPa·s or more. The viscosity was measured three times for each emulsified composition, and the average value was adopted. Table 1 shows the measurement results. For Comparative Examples 1 and 2 in which measurement was not possible because the emulsified composition separated immediately after production, the results are indicated as unmeasured (“-”) in Table 1.

### (Ease of Addition of Fat and Oil 1)

### <Test of Addition to Drinking Water>

The ease of addition of fat and oil when the emulsified compositions of Examples 1 to 8 and Comparative Examples 1 to 4 prepared above were added to drinking water was evaluated according to the following criteria. The evaluation results are shown in Table 1. In the following evaluation, if the evaluation is 2 points or more, it can be said that the result is favorable. For Comparative Examples 1 and 2 in which measurement was not possible because the emulsified composition separated immediately after production, the results are indicated as unmeasured (“-”) in Table 1.

### Evaluation Criteria for Ease of Addition of Emulsified Composition

5: Stirring simply with a medicine spoon allowed immediate emulsification, leaving no lumps.

4: Stirring simply with a medicine spoon allowed emulsification, leaving no lumps.

3: Stirring simply with a medicine spoon and mixing for a while allowed emulsification, leaving some lumps.

2: Stirring vigorously with a medicine spoon and mixing for a while allowed emulsification, leaving some lumps.

1: Stirring vigorously with a medicine spoon and mixing for a while did not allow sufficient emulsification, leaving many lumps.

### (Ease of Addition of Fat and Oil 2)

### <Test of Addition to Liquid Nutritional Food>

The ease of addition of fat and oil when the emulsified compositions of Examples 1 to 8 and Comparative Examples 1 to 4 prepared above were added to Mei Balance Mini Cup (manufactured by Meiji Co., Ltd.) was evaluated according to the criteria described above. The evaluation results are shown in Table 1.

TABLE 1

| Composition | Ex. 1 | Ex. 2 | Ex. 3 | Ex. 4 | Ex. 5 | Ex. 6 | Ex. 7 |
|---|---|---|---|---|---|---|---|
| Edible fat and oil | 7.4 | 17.4 | 32.4 | 32.2 | 47.4 | 57.2 | 50.0 |
| Sugar alcohol | 64.4 | 57.4 | 46.9 | 49.2 | 36.4 | 25.2 | 31.5 |
| Glycerin | 0.0 | 0.0 | 0.0 | 0.0 | 0.0 | 0.0 | 0.0 |
| Ionic surfactant | 0.6 | 0.6 | 0.6 | 0.6 | 0.6 | 1.8 | 5.0 |
| (lysophospholipid) | | | | | | | |
| Moisture | 27.6 | 24.6 | 20.1 | 18.0 | 15.6 | 15.8 | 13.5 |
| Total (% by mass) | 100.0 | 100.0 | 100.0 | 100.0 | 100.0 | 100.0 | 100.0 |
| L2 value − L1 value | 4.3 | 16.8 | 18.2 | 23.5 | 31.5 | 28.1 | 23.9 |
| Specific gravity | 1.25 | 1.22 | 1.14 | 1.12 | 1.05 | 1.03 | 1.02 |
| Viscosity (mPa · s) | 600 | 1300 | 3500 | 4000 | 9000 | 29000 | 45500 |
| Content of ionic | 0.081 | 0.034 | 0.019 | 0.019 | 0.013 | 0.031 | 0.100 |
| surfactant with | | | | | | | |
| respect to 1 part by | | | | | | | |
| mass of oil content | | | | | | | |
| (parts by mass) | | | | | | | |
| Ease of addition of | 5 | 5 | 5 | 5 | 4 | 3 | 2 |
| fat and oil 1 | | | | | | | |
| Ease of addition of | 5 | 5 | 5 | 5 | 4 | 3 | 2 |
| fat and oil 2 | | | | | | | |

| | Comp. | Comp. | Comp. | | Comp. |
|---|---|---|---|---|---|
| Composition | Ex. 1 | Ex. 2 | Ex. 3 | Ex. 8 | Ex. 4 |
| Edible fat and oil | 94.0 | 67.4 | 84.0 | 62.0 | 60 |
| Sugar alcohol | 3.5 | 22.4 | 0.0 | 0.0 | 0.0 |
| Glycerin | 0.0 | 0.0 | 15.0 | 35.5 | 30 |
| Ionic surfactant | 1.0 | 0.6 | 1.0 | 2.5 | 10 |
| (lysophospholipid) | | | | | |
| Moisture | 1.5 | 9.6 | 0.0 | 0.0 | 0.0 |
| Total (% by mass) | 100.0 | 100.0 | 100.0 | 100.0 | 100 |
| L2 value − L1 value | — | — | 17.3 | 21.0 | 28.0 |
| Specific gravity | — | — | 0.94 | 1.04 | 1.02 |
| Viscosity (mPa · s) | — | — | >100000 | 49500 | >100000 |
| Content of ionic | 0.011 | 0.009 | 0.012 | 0.040 | 0.167 |
| surfactant with | | | | | |
| respect to 1 part by | | | | | |
| mass of oil content | | | | | |
| (parts by mass) | | | | | |
| Ease of addition of | — | — | 1 | 3 | 1 |
| fat and oil 1 | | | | | |
| Ease of addition of | — | — | 1 | 3 | 1 |
| fat and oil 2 | | | | | |

As is clear from the results in Table 1, for all of the emulsified compositions of Examples 1 to 4 when added to a drink and a liquid nutritional food, stirring simply with a medicine spoon allowed immediate emulsification, leaving no lumps. Note that since the emulsified composition of Example 1 had a low fat and oil content, it was insufficient for the purpose of adding fat and oil to a food or drink product.

When the emulsified composition of Example 5 was added to a drink and a liquid nutritional food, stirring with a medicine spoon allowed emulsification, leaving no lumps.

When each of the emulsified compositions of Examples 6 and 8 was added to a drink and a liquid nutritional food, stirring simply with a medicine spoon and mixing for a while allowed emulsification, leaving some lumps.

When the emulsified composition of Example 7 was added to a drink and a liquid nutritional food, stirring vigorously with a medicine spoon and mixing for a while allowed emulsification, leaving some lumps.

When each of the emulsified compositions of Comparative Examples 3 and 4 was added to a drink and a liquid nutritional food, stirring vigorously with a medicine spoon and mixing for a while did not allow sufficient emulsification, leaving many lumps.

### (Ease of Addition of Fat and Oil 3)

### <Test of Addition to Vegetable Soup>

The ease of addition of fat and oil when the emulsified compositions of Examples 1 to 4 prepared above were added to Kokusan Rokushu Yasai no Soup (Soup with Six Kinds of Domestically Produced Vegetables) (manufactured by MCC FOOD PRODUCTS CO., LTD.) was evaluated according to the criteria described above.

As a result, when each of the emulsified compositions of Examples 1 to 4 was added to the vegetable soup, stirring simply with a medicine spoon allowed immediate emulsification, leaving no lumps.

### (Ease of Addition of Fat and Oil 4)

<Test of Addition to Food Product for Those with Difficulty in Swallowing>

The ease of addition of fat and oil when the emulsified compositions of Examples 1 to 4 prepared above were added to a food product for those with difficulty in swallowing (Yasashii Kondate: Nameraka Yasai (Ninjin) (Care Menu: Smooth Vegetable (Carrot)) manufactured by Kewpie Corporation) was evaluated according to the criteria described above.

As a result, when each of the emulsified compositions of Examples 1 to 4 was added to the food product for those with difficulty in swallowing, stirring simply with a medicine spoon allowed immediate emulsification, leaving no lumps.

1. An emulsified composition for adding fat and oil to a food or drink product, wherein
the emulsified composition contains fat and oil, an ionic surfactant, and a polyhydric alcohol,
a content of the fat and oil is 5% by mass or more and 65% by mass or less with respect to a total amount of the emulsified composition,
a content of the ionic surfactant is 0.3% by mass or more and 6.0% by mass or less with respect to the total amount of the emulsified composition,
the ionic surfactant contains at least lecithin and/or lysolecithin,
the emulsified composition has a specific gravity of 1.0 or more at 20° C. and
a viscosity of 60,000 mPa·s or less at 20° C., and
a difference of L2 value-L1 value calculated by the following definition at 20° C. is positive:
L1 value: lightness value of the emulsified composition;
L2 value: lightness value of the emulsified composition obtained by adding 100 times by mass of fresh water to the emulsified composition.

2. The emulsified composition according to claim 1, wherein the content of the ionic surfactant is 0.15 parts by mass or less with respect to 1 part by mass of the content of the fat and oil.

3. The emulsified composition according to claim 1, wherein the polyhydric alcohol contains a sugar alcohol.

4. The emulsified composition according to claim 3, wherein an average molecular weight of the sugar alcohol is 100 or more and 2000 or less.

5. The emulsified composition according to claim 1, wherein a content of the polyhydric alcohol is 20% by mass or more in terms of solid content with respect to the total amount of the emulsified composition.

6. The emulsified composition according to claim 1, having a moisture content of from 5% by mass or more with respect to the total amount of the emulsified composition.

7. The emulsified composition according to claim 1, wherein the difference of L2 value-L1 value is 10.0 or more.

8. The emulsified composition according to claim 1, wherein the food or drink product is selected from the group consisting of a drink, a liquid food, a liquid nutritional food, and a food or drink product for those with difficulty in chewing and/or swallowing.

9. An emulsified composition for adding fat and oil to a liquid nutritional food or a food or drink product for those with difficulty in chewing and/or swallowing, having
a viscosity of 60,000 mPa·s or less at 20° C.,
wherein a difference of L2 value-L1 value calculated by the following definition at is positive:
L1 value: lightness value of the emulsified composition;
L2 value: lightness value of the emulsified composition obtained by adding 100 times by mass of fresh water to the emulsified composition.

10. A food or drink product to which the emulsified composition according to claim 1 is added.
